(19) United States
(12) Patent Application Publication
(10) Pub. No.: US 2010/0266976 A1
(43) Pub. Date: Oct. 21, 2010

(54) ORTHODONTIC FUNCTIONAL APPLIANCE

(75) Inventor: Zhichun Song, Shandong Province (CN)

Correspondence Address: MERCHANT & GOULD PC, P.O. BOX 2903, MINNEAPOLIS, MN, 55402-0903, US

(73) Assignee: MDD MEDICAL EQUIPMENT CO, LTD., QINGDAO, Qingdao, Shandong Provence (CN)

(21) Appl. No.: 12/740,981

(22) PCT Filed: Mar. 10, 2008
(86) PCT No.: PCT/CN2008/000470

§ 371 Date: Apr. 30, 2010

(30) Foreign Application Priority Data
Dec. 7, 2007 (CN) 200710116142.4

(51) Int. Cl. A61C 7/14

(52) U.S. Cl. 433/8

(57) ABSTRACT

An oral functional appliance for adjusting functions of oral muscle organs includes a base and a body. The base is connected to a tooth surface, and the body is provided with at least one protrusion at a surface thereof.

### FIELD OF THE INVENTION

The present invention relates to an appliance involved in an orthodontics field, in particular to an appliance for adjusting functions of oral muscle organs.

### THE RELATED ART

For functional adjustment of tongue muscles, a tongue crib or tongue tag is generally made on a removable appliance to prevent the tongue from extending forward, so as to facilitate retraction of lower tooth, or to correct anterior open bite and eliminate tongue thrust habit. Such a removable appliance is complex to manufacture, bulky and may cause uncomfortable feeling in patients.

For functional adjustment of lip muscles, a crib or lip tag is generally mounted on a removable appliance to eliminate lip biting habit. Such a removable appliance is complex to manufacture, bulky and may cause uncomfortable feeling in patients.

### SUMMARY OF THE INVENTION

The technical problem to be solved by the present invention is to design an orthodontic functional appliance, which may adjust functions of oral muscles, facilitate teeth movement, correct bad habits, and which is also easy and convenient to use with significant curative effect.

To address the above technical problem, the present invention uses a technical solution that includes a base connected to a tooth surface and a body provided with at least one protrusion.

The orthodontic functional appliance using this technical solution may have one protrusion.

The orthodontic functional appliance using this technical solution may have two protrusions, which direct in one and the same direction or in different directions, respectively.

The orthodontic functional appliance using this technical solution may have three protrusions, which direct in one and the same direction or in different directions, respectively.

The orthodontic functional appliance using this technical solution may have more than three protrusions, which direct in one and the same direction or in different directions, respectively.

The orthodontic functional appliance using this technical solution may be provided with a hole extending through the body.

The orthodontic functional appliance using this technical solution is provided with a hole extending through the body, such that two or more orthodontic functional appliances may be connected together by passing a wire through their respective holes.

The orthodontic functional appliance using this technical solution is provided with a hole extending through the body, thereby the orthodontic functional appliance may be bound with a tooth, which is located under the appliance, by passing a wire through the hole.

With the orthodontic functional appliance using this technical solution, two or more said orthodontic functional appliances are connected together by means of a connector provided at their respective bases and/or their respective body.

In such a way that two or more orthodontic functional appliances are connected, when one or more of the orthodontic functional appliance falls off, the fallen one or ones can be found rapidly. Therefore, such orthodontic functional appliances are safe and not easy to be swallowed by mistake.

The orthodontic functional appliance using this technical solution may be made of metal, ceramic, plastic and other suitable materials.

With the orthodontic functional appliance using this technical solution, the base may be connected to a tooth by using adhesive.

With the orthodontic functional appliance using this technical solution, the base may be connected with a band which is to be adhered to a tooth.

With the orthodontic functional appliance using this technical solution, the body may further be designed with various dental appliances. For example, a lingual bracket may be made integrally with the orthodontic functional appliance.

With the orthodontic functional appliance using this technical solution, the protrusion may be designed to have a tip of a needle shape or a round shape.

With the orthodontic functional appliance using this technical solution, the protrusion may be configured to protrude outward in a direction at an angle of 0-90° with respect to a base surface, such that it is possible to affect the movement and position of oral muscle organs as desired, so as to obtain a better effect.

With the orthodontic functional appliance using this technical solution, the protrusion may be designed to have different postures as desired, and also the protrusion may have different heights as desired.

With the orthodontic functional appliance using this technical solution, the base may be of a planar, a concave or a convex structure, which allows the base to accommodate the shape of various surfaces of the respective tooth, such as buccal and labial surfaces, a lingual surface, and medial and distal surfaces and the like, and thus facilitates the connection with the tooth.

With the orthodontic functional appliance using this technical solution, it is possible to design other structures on this orthodontic functional appliance, as long as the base is jointed to a tooth surface directly or indirectly and the body has one or more protrusions. All of them fall within the scope of protection of the present invention.

The force applied on teeth by oral muscle organs (such as tongues, lips, cheeks and the like) can be prevented or decreased by the protrusion. In cases of class III malocclusion and mandibular prognathism, etc., retraction of lower anterior teeth is needed. Here, the tongue applies a larger pressure on the mandibular teeth, and thus the retraction of the lower teeth is subjected to a larger resistance. Therefore, if the lower teeth are retracted directly, a facebow or an implant would be often needed so as to strengthen anchorage. In this case, however, if a plurality of the orthodontic functional appliances described above is fitted at a lingual side of the lower teeth, the pressure applied on the lower anterior teeth by the tongue may be greatly reduced. Therefore, the retraction of the lower anterior teeth with a light force can be achieved without strengthening the anchorage, while anchorage of the posterior teeth has no loss substantially.

For open bite patients with tongue thrusting habit, a plurality of the orthodontic functional appliances may be fitted on the lingual side of the upper and lower teeth, which may prevent excessive tongue protrusion and help correct the tongue thrusting habit and open bite occlusion.

For patients with the lip biting habit, a plurality of the orthodontic functional appliances may be fitted at the labial side and/or the lingual side of upper and lower anterior teeth, which may prevent the patients from biting upper and lower lips. For patients who have a habit of biting upper lip, it is possible to adhere the above described orthodontic functional appliance to the labial side of upper teeth and/or the lingual side of lower teeth; and for patients who have a habit of biting lower lip, it is possible to adhere the above described orthodontic functional appliance to the labial side of lower teeth and/or the lingual side of upper teeth. In this way, the patients will be tingled by the protrusion of the above described orthodontic functional appliance, therefore, lip biting habit may be corrected progressively.

For tooth extracted patients, the orthodontic functional appliance may be fitted on the surfaces of the teeth (e.g. the distal surface of the medial teeth and/or the medial surface of the distal teeth) located at both sides of an extraction gap, so as to prevent the tongue from thrusting into the extraction gap and thus facilitate closing of the gap.

Since the tongue moves flexibly and may be stretched out in various directions, the orthodontic functional appliance fitted at a lingual side is preferably designed to have more than two protrusions thereon, which are directed in different directions.

The present device may adjust functions of oral muscles, facilitate teeth movement, correct bad habits, and is easy and convenient to use with significant curative effect.

### BRIEF DESCRIPTION OF THE DRAWINGS

The present invention will be described below in further details in conjunction with drawings and specific embodiments.

FIG. 1 is a side view of a first embodiment of the present invention;

FIG. 2 is a front view of the first embodiment of the present invention;

FIG. 3 is a perspective view of the first embodiment the present invention;

FIG. 4 is a back view of the first embodiment of the present invention;

FIG. 5 is a side view of a third embodiment of the present invention;

FIG. 6 is side view of a fourth embodiment of the present invention;

FIG. 7 is front view of a fifth embodiment of the present invention;

FIG. 8 is a schematic view showing use of the first embodiment of the present invention; and

FIG. 9 is a schematic view showing use of a second embodiment of the present invention.

### DETAILED DESCRIPTION OF THE INVENTION

### The First Embodiment

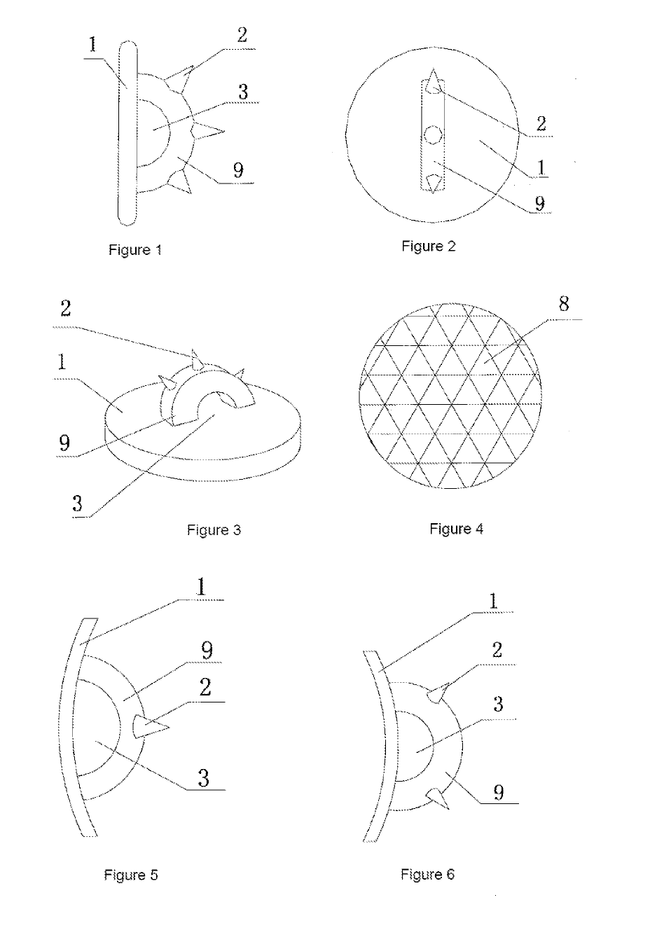

An orthodontic functional appliance shown in FIGS. 1-3 mainly includes a base 1 and a body 9. The base 1 is of a planar structure, and the body 9 is a semi-cylinder. The base 1 is connected to a tooth surface. The body 9 has three protrusions 2 thereon, which protrude outward in directions at angle of 45°, 90° and 45° with respect to a base surface, respectively. Tips of the protrusions 2 are designed to be needle-shaped. A hole 3 passing through the body 9 is provided in the body 9 in a direction parallel to the base.

As shown in FIGS. 4 and 8, the base surface of the orthodontic functional appliance is provided with a mesh layer, which may be connected with tooth surface through an adhesive. Three orthodontic functional appliances adhered to a tooth surface 6 are connected together by a wire 5 passing through the respective holes 3 formed in these orthodontic functional appliances. In this way, if one of the orthodontic functional appliances falls off, no mistake swallow will occur and the fallen one can be found rapidly.

### The Second Embodiment

As shown in FIG. 9, this embodiment differs from the first embodiment in that three orthodontic functional appliances adhered to the tooth surfaces 6 are connected through a connector 4 provided on the base 1. The connector 4 is integral with the orthodontic functional appliance, made of the same material as that of the orthodontic functional appliance and is casted together with the orthodontic functional appliance. In this way, if one of the orthodontic functional appliances falls off, no mistake swallow will occur and the fallen one can be found rapidly.

### The Third Embodiment

As shown in FIG. 5, this embodiment differs from the first embodiment in that only one protrusion 2 is provided on the body 9 of the orthodontic functional appliance, and the protrusion protrudes outward in a direction at an angle of 90° with respect to the base surface. The base 1 is of a convex structure.

### The Fourth Embodiment

As shown in FIG. 6, this embodiment differs from the first embodiment in that two protrusions 2 are provided on the body 9 of the orthodontic functional appliance, and the protrusions respectively protrude outward in a direction at an angle of 45° with respect to the base surface. The base 1 is of a concave structure.

### The Fifth Embodiment

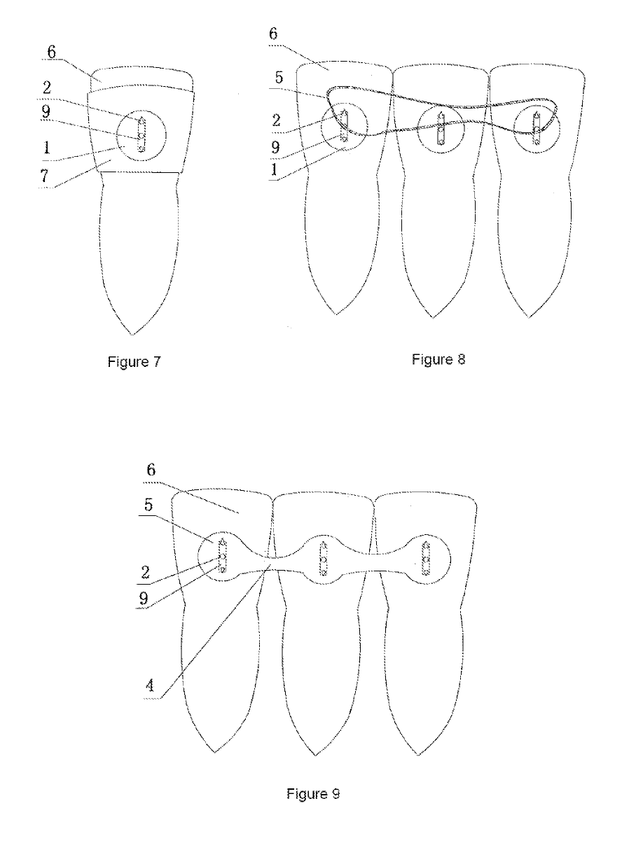

As shown in FIG. 7, this embodiment differs from the first embodiment in that the base 1 of the orthodontic functional appliance is welded with a band 7 and the band 7 is to be adhered to the tooth surface.

1.-10. (canceled)

11. An orthodontic functional appliance, comprising a base and a body, the base of each orthodontic functional appliance being connected to a surface of only one tooth, and the body being provided with at least one protrusion, wherein the protrusion has a needle-shaped tip, and the body is provided with a hole extending there through.

12. The orthodontic functional appliance according to claim 11, wherein two or more said orthodontic functional appliances adapt to be connected together by a wire passing through their respective holes.

13. The orthodontic functional appliance according to claim 11, wherein the orthodontic functional appliance adapts to be bound with a tooth, which is located under the appliance, by passing a wire through the hole.

14. The orthodontic functional appliance according to claim 11, wherein the base is adhered to a tooth surface through an adhesive.

15. The orthodontic functional appliance according to claim 11, wherein the orthodontic functional appliance is further designed with other universal orthodontic appliance.

16. The orthodontic functional appliance according to claim 11, wherein the protrusion protrudes outward in a direction at an angle of 0-90° with respect to a surface of the base.

17. The orthodontic functional appliance according to claim 11, wherein the base of the orthodontic functional appliance is of a planar, a concave or a convex structure.

18. The orthodontic functional appliance according to claim 11, wherein the orthodontic functional appliance can be connected to a labial surface or a lingual surface of an upper or lower anterior tooth.
